(19) United States
(12) Patent Application Publication
(10) Pub. No.: US 2014/0015416 A1
(43) Pub. Date: Jan. 16, 2014

(54) LAMP DRIVING MODULE

(71) Applicants: Zoltan SOMOGYVARI, Budapest (HU); Tamas BOTH, Budapest (HU); Miklos BUDAI, Budapest (HU); Qian NI, Shanghai (CN); Chenghua ZHU, Shanghai (CN)

(72) Inventors: Zoltan SOMOGYVARI, Budapest (HU); Tamas BOTH, Budapest (HU); Miklos BUDAI, Budapest (HU); Qian NI, Shanghai (CN); Chenghua ZHU, Shanghai (CN)

(21) Appl. No.: 13/546,916

(22) Filed: Jul. 11, 2012

(51) Int. Cl. H05B 41/36

(52) U.S. Cl. 315/151; 315/307

(57) ABSTRACT

A lamp driving module for a gas-discharge lamp includes a lamp ballast module, and a lamp power control module coupled to the lamp ballast module. The lamp power control module is configured to drive the lamp in a DC mode during a run-up state and in an AC mode when not in the run-up state. The lamp power control module is configured to heat the amalgam in the lamp more quickly, accelerate migration of the released mercury vapor throughout the lamp discharge tube, and allow the lamp to get brighter faster.

### BACKGROUND

1. Field

The present disclosure generally relates to gas discharge lamps, and more particularly to driving modules for gas-discharge lamps.

2. Description of Related Art

A gas-discharge lamp belongs to a family of electroluminescent devices that generate light by passing electric current through a gas or vapor within the lamp. Atoms in the vapor absorb energy from the electric current and then release the absorbed energy as light. One of the best known types of gas discharge lamps is the fluorescent lamp. Fluorescent lamps contain mercury vapor whose atoms emit light in the non-visible low wavelength ultraviolet region. The ultraviolet radiation then causes a phosphor disposed on the interior of the lamp tube to fluoresce, producing visible light.

Typical fluorescent lamps contain small amounts of liquid mercury. When the lamp is turned on, the liquid mercury is heated and evaporates to form mercury vapor for light production within the lamp. Fluorescent lamps containing liquid mercury pose an environmental threat because, if not disposed of properly, the liquid mercury, a dangerous heavy metal, can be released into the environment. A less harmful and eco-friendlier alternative is to alloy mercury with other materials to create an amalgam that has a stable solid form at room temperature. These amalgams retain the mercury at low temperatures and only release it at temperatures above about 100° C. under normal atmospheric pressures. The equilibrium vapor pressure above the amalgams (at the same temperature) is lower than above liquid mercury, consequently the Hg release after accidental breakage of the lamp is slower, this is the primary reason why amalgam dosed, lamps are considered less harmful. Compact type fluorescent lamps operate at higher temperatures, this necessitates the application of amalgams to reduce the vapor pressure inside the lamp to the vicinity of the optimum value.

In practice, fluorescent lamps are nearly always driven with alternating current (AC), which allows the lamp current to be controlled using an inductor or other type of reactive module that limits the flow of alternating current without dissipating energy. These current controlling modules are generally referred to as ballast modules or “ballasts”. In practice, the term ballast is commonly used to refer to the entire fluorescent lamp drive module, not just the current limiting portion.

Fluorescent lamps use significantly less energy than incandescent lamps with comparable brightness. Because of this, it is desirable to replace incandescent lighting with fluorescent lighting. A compact fluorescent lamp (CFL) is a type of fluorescent lamp designed to replace standard incandescent light bulbs. Some compact fluorescent lamps are designed to fit into light fixtures designed for standard incandescent lamps. These CFLs typically have tubes that are curved or folded to fit into the space of a standard bulb and typically use the same Edison type screw connectors. Popular CFLs have permanently attached tubes with integrated electronic ballasts built into the base of the lamp.

FIG. 1 illustrates the basic parts of a typical fluorescent lamp, such as a compact fluorescent lamp 100, as is generally known in the art. The lamp 100 in this example includes a sealed discharge tube 102 or a light transmissive envelope, preferably formed of a material that is transmissive to radiation in the visible spectrum. The discharge tube 102 encloses a sealed volume or discharge chamber 104. At least a portion of the interior surface of the tube 102 is provided with a phosphor coating 106 to convert ultraviolet (UV) light emitted from mercury ions in the discharge chamber 104 into visible light. A gaseous discharge fill or fill gas is contained within the discharge chamber 104. The fill gas is at a low pressure and typically includes an inert gas such as argon, or a mixture of argon and other rare gases such as xenon, krypton, and neon, usually in combination with a small quantity of mercury to provide a desired low vapor pressure for operation of the lamp 100. The amount of dosed mercury does not affect the Hg vapor pressure. It is set by the temperature of the coldest spot of the lamp.

In the example of FIG. 1, the discharge tube 102, also referred to as the “lamp tube”, is in the form of a U-shaped tube 108 having a generally circular cross section. In alternate embodiments, as is generally understood, a wide variety of configurations, shapes and numbers of tubes 108 are commonly used. The tube 108 may also have generally parallel leg sections 116, 118 and a transverse bridging or light section 120 joining one end of each of the leg sections 116, 118. The opposite end of each of the leg sections 116, 118 is closed.

Electrode structures 126 are placed at each end of the discharge tube 102 such that a generally elongated discharge path is formed within the discharge chamber 104. The electrode structure 126, also referred to as an electrode 126, includes lead-in wires 128, insulated support 130, and filament 124. The filament portion 124 of the electrodes 126 may be of a filament coil type. Each filament 124 is supported within the discharge tube 102 by the electrical lead-in wires 128 that supply electrical energy to the filament 124 and the electrically insulated support 130 connecting and supporting the electrical lead-in wires 128 below each filament 124. The electrical lead-wires 128 extend through a stem 132 which is pinched or sealed to hermetically seal the discharge tube 102.

A main amalgam member 150 is provided within the gas discharge tube 102, preferably located in the exhaust tube 138. The exhaust tube 138 is a portion of a fluorescent lamp, typically located near the ends of the tube 102, which is used during manufacturing to remove gas from and/or introduce gas into the lamp 100. Typically, the amalgam 150 is a metal alloy such as an alloy containing a bismuth-indium-mercury (Bi—In—Hg) composition. The main amalgam may also contain tin, zinc, silver, gold and combinations thereof. The particular composition is chosen to be compatible with the operating temperature characteristic of its location in the discharge tube 102. As such, the alloy is generally ductile at temperatures of about 100° C. The alloy may become liquid at higher lamp operating temperatures. Once the working temperature is reached, the main amalgam 150 holds the correct mercury vapor pressure.

In fluorescent lamps that contain an amalgam, most of the mercury is retained in the amalgam 150 at room temperature and there is only a small amount of mercury vapor present to ignite the lamp 100. These lamps require a warm-up time, or run-up period, during which the amalgam 150 is heated to release additional mercury vapor resulting in an increasing light output. The run-up period is the amount of time required for a lamp to reach full brightness after it is turned on. It is not unusual for these lamps to produce less than 50% of their full brightness when first started and take several minutes to reach full brightness. However, it is desirable to minimize the time for these types of lamps to reach their full brightness and standards are being introduced that define minimum warm-up or run-up time requirements. Thus, there exists a need for fluorescent lamps and CFLs that produce light with high efficiency and have reduced run-up times.

Accordingly, it would be desirable to provide gas discharge lamps and systems that solve at least some of the problems identified above.

### SUMMARY OF THE INVENTION

As described herein, the exemplary embodiments overcome one or more of the above or other disadvantages known in the art.

One aspect of the exemplary embodiments relates to a lamp driving module for a gas-discharge lamp. In one embodiment, the lamp driving module includes a lamp ballast module, and a lamp power control module coupled to the lamp ballast module. The lamp power control module is configured to drive the lamp in a DC mode during a run-up state.

Another aspect of the present disclosure relates to a gas-discharge lamp assembly. In one embodiment the gas-discharge lamp assembly includes a ballast module, a lamp driving module coupled to the ballast module and configured to produce a lamp power signal, and a lamp coupled to the lamp driving module and configured to receive the lamp power signal for operation of the lamp. The lamp driving module is configured to provide a DC power signal or an AC power signal to the lamp.

Another aspect of the present disclosure relates to a method for driving a gas-discharge lamp. In one embodiment, the method includes applying a DC power to operate the lamp during a run-up state, and applying an AC power to operate the lamp at an end of run-up state.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Moreover, the drawings are not necessarily drawn to scale and unless otherwise indicated, they are merely intended to conceptually illustrate the structures and procedures described herein.

### BRIEF DESCRIPTION OF THE DRAWINGS

In the drawings:

FIG. 1 illustrates a typical fluorescent lamp as is known in the art.

FIG. 2 illustrates a block diagram of an exemplary gas-discharge lamp assembly incorporating aspects of the present disclosure.

FIG. 3 illustrates a block diagram of an exemplary lamp driving module for a gas-discharge lamp incorporating aspects of the disclosed embodiments.

FIG. 4 illustrates a graph of light output versus time for various gas-discharge lamp assemblies incorporating aspects of the present disclosure.

FIG. 5 is a schematic diagram of one embodiment of the exemplary lamp driving module shown in FIG. 3.

FIG. 6 illustrates a flow diagram of one embodiment of an exemplary method for driving a gas-discharge lamp, incorporating aspects of the present disclosure.

### DETAILED DESCRIPTION OF THE DISCLOSED EMBODIMENTS

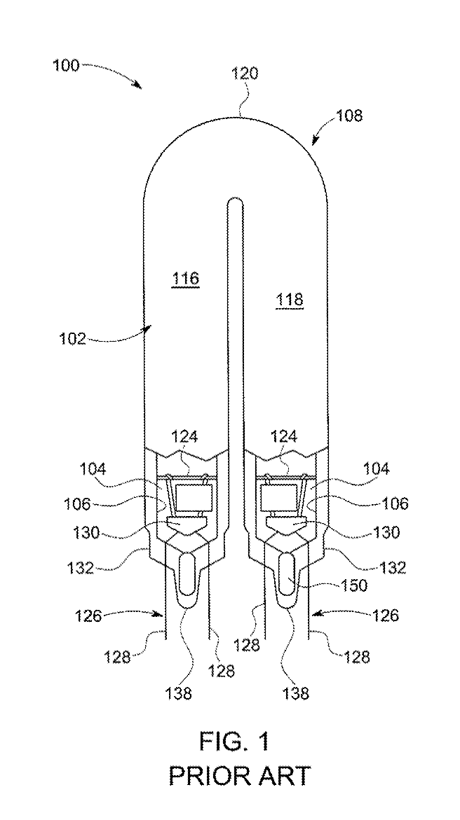

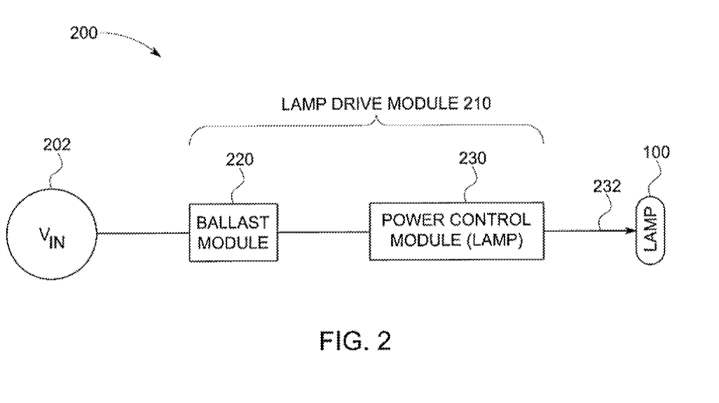

Referring to FIG. 2, a block diagram of an exemplary embodiment of a gas-discharge or fluorescent lamp assembly or system 200 incorporating aspects of the present disclosure is illustrated. The aspects of the present disclosure are directed to a gas-discharge lamp driving module that starts a fluorescent lamp in a direct current (DC) mode and operates the lamp using the DC mode for a preset or predetermined time period, generally referred to herein as a start-up or run-up period. The start-up or run-up period of fluorescent lamp generally refers to the period from lamp ignition until the light output of the lamp reaches a steady operating brightness. When a lamp is initially ignited, its light output is significantly below its normal operating value. As the lamp heats up the light output of the lamp will increase. The aspects of the disclosed embodiments advantageously accelerate the heating of the amalgam in a fluorescent lamp and accelerate a dispersion of mercury vapor released by the amalgam throughout the discharge tube. At the expiration of the preset time period, the assembly 200 switches back to a more typical alternating current (AC) mode. This reduces the run-up time of the lamp and allows the lamp to get brighter faster. In the example shown in FIG. 2, the assembly 200 includes the exemplary fluorescent lamp 100 shown in FIG. 1 for illustration purposes only. However, it will be understood that the aspects of the disclosed embodiments provide a driving module to start any suitably configured fluorescent lamp using amalgam.

In the embodiment shown in FIG. 2, the fluorescent lamp assembly 200 generally includes a lamp driving module 210 that is electrically coupled between a power input V_{IN} 202 aid a lamp 100, such as lamp 100 of FIG. 1. The lamp driving module 210 generally includes a ballast module 220 and a lamp power control module 230. The ballast module 220 can generally comprise a typical AC lamp ballast module as will be understood in the art. The lamp power control module 230 is configured to detect the initial activation of the lamp 100 and drive the lamp 100 during the start-up or run-up period in the DC mode. An output 232 of the lamp power control module 230 is used to drive or operate the lamp 100. At the end of the run-up period, or such other suitable period as is generally defined herein, the lamp power control module 230 is configured to switch the operation or driving of the lamp 100 back to a standard, more typical, AC mode. The lamp power control module 230 is configured to heat the amalgam 150 in the lamp 100 more quickly, accelerate migration of the released mercury vapor throughout the discharge tube 102, and thus allow the lamp or light 100 to get brighter faster.

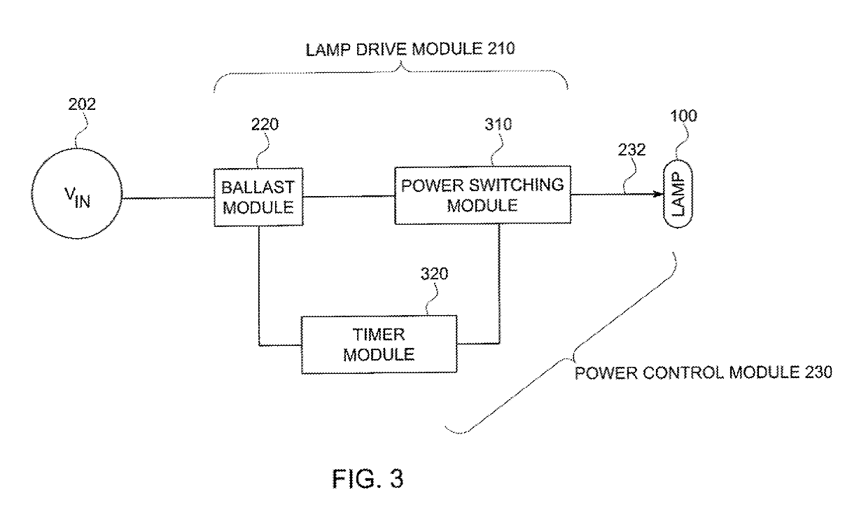

Referring to FIG. 3, in one embodiment, the lamp power control module 230 of the lamp driving module 210 shown in FIG. 2 includes a power switching module 310 and a timer 320. In this example, where the run-up period is time dependent, the power switching module 310 is configured to take the AC output from the ballast module 220 and drive or power the lamp 100 with a DC or AC power signal, depending on the state of the timer module 320. As will be discussed in more detail below, the power switching module 310 may be advantageously employed to selectively apply DC power and/or AC power to the lamp 100 in order to reduce the amount of run-up time required for the lamp 100 to reach full brightness. In some embodiments, the power switching module 310 includes ballasting components to control the amount of current flowing through the lamp 100 or alternatively the ballasting components may be incorporated into the ballast module 220 or in both the ballast module 220 and the lamp power control module 230.

The lamp driving module 210 shown in FIG. 2 is generally configured to start the lamp 100 in a DC mode and operate the lamp 240 in the DC mode for a predetermined time period, generally corresponding to the run-up period of the lamp 100. This generally occurs or starts when power is first applied to the lamp driving module 210, such as when a power switch (not shown) is activated or turned on. At the expiration of the predetermined time period, the timer module 320 of FIG. 3 causes the power switching module 310 to operate the lamp 100 in an AC mode, as is generally understood.

As noted above, fluorescent lamps (FL) using an amalgam, such as lamp 100 shown in FIG. 1, require a run-up period to attain full brightness. When a cold fluorescent lamp is turned on, much of the mercury is contained in the amalgam 150 and only a small amount of mercury vapor is present to ignite the lamp 100 and produce light. After ignition, the amalgam 150, usually placed at one or both ends of the lamp tube 102, is heated to release additional mercury vapor which spreads throughout the lamp tube 102 thereby increasing light output of the lamp 100. During ran-up, there are two physical phenomena contributing to the increasing light output: electron heating of the filaments 124 where the amalgam 150 is heated to release additional mercury vapor, and migration of the mercury vapor away from the amalgam 150 spreading throughout the lamp tube 102. Accelerating either or both of these physical phenomena will reduce the run-up time of a fluorescent lamp. As is disclosed herein, driving the lamp 100 with direct current (DC) during at least part of the run-up period can accelerate one or both of these phenomena resulting in significantly shorter run-up times.

Electrons impinging on the filaments 124 of the fluorescent lamp 100 cause electron heating of the electrodes 126, which in turn heats other components of the lamp 100. An electrode 126 that receives positive electric current is referred to as an anode, and an electrode 126 receiving negative electric current is referred to as a cathode, i.e. electrons enter the lamp 100 at the cathode and exit the lamp 100 at the anode. By convention, DC power has a supply side and a return side, where the supply side refers to the positively charged side of the DC power that supplies positive electric current to the lamp 100, i.e. the anode of the lamp 100 is connected to the supply side of the DC power. When the lamp 100 is driven with AC current, the electrodes 126 alternate between functioning as an anode and a cathode as the polarity of the current changes. Electrons impinging on the anode or emanating from the cathode prefer those surfaces where the electrical resistance is lower. In the cathode cycle, electrons are emitted via thermionic emission and the current density depends on the local work function and local temperature as well. In the cathode cycle the majority of electrons emanate from a small spot on the coated part of the electrode. These surfaces are typically on the lead-in wires 128 and the uncoated parts of tungsten filaments 124. At the anode side, the whole energy of the electrons is transferred to heat, while at the cathode side, a significant part of the energy of ion bombardment is used to perform the work of emitting electrons. As a consequence, the anode side filament 124 and lead-in wires 128 heat up faster and to a higher temperature than those at the cathode side. By driving the lamp 100 with DC power during the start-up or run-up period, using the lamp driving module 210 of FIG. 2, the higher level of heating at the anode side can be utilized to heat the amalgam 150 faster than is possible in standard AC ballast powered operations.

The exemplary lamp driving module 210 shown in FIG. 2 typically receives input power 202 from a suitable power source (not shown). The input power 202 is generally in the form of an alternating current (AC) power. Suitable sources of AC power can include, but are not limited to, the local mains voltages typically supplied by the electrical utility such as the 110 volt root-mean-square (Vrms) 60 Hertz (Hz) power available in North America or the 230 Vrms 50 Hz power available in Europe.

Once mercury vapor is released from the heated amalgam 150 it needs to be disbursed generally evenly throughout the discharge tube 102 to attain full brightness of the lamp 100. Typically, dispersion is achieved by diffusion currents which tend to move ions from areas of greater concentration, such as the areas near the amalgam 150, to areas of lesser concentration. An electro kinetic phenomenon known as electrophoresis, also referred to as cataphoresis, can be used to accelerate dispersion of the mercury vapor throughout the lamp tube. Electrophoresis acts to move mercury ions in a direction opposite to electron flow i.e. from the anode to the cathode. The resultant flow of ionic mercury (Hg⁺) vapor or material flow is represented as a function J(Hg⁺), which is mathematically related to the mercury density (nHg⁺), the mobility of the mercury ions in the fill gas (μHg⁺), and the electric field (E):

J(Hg⁺)=nHg⁺*μHg⁺*E.

Assuming low mercury pressures, which are typical for the initial operating time of amalgam lamps, the electrophoretic material flow is significantly greater than the normal diffusion current resulting from the uneven distribution of mercury. The electrophoretic drift may be more than an order of magnitude higher than the normal diffusion current during a period of time right after ignition of the lamp.

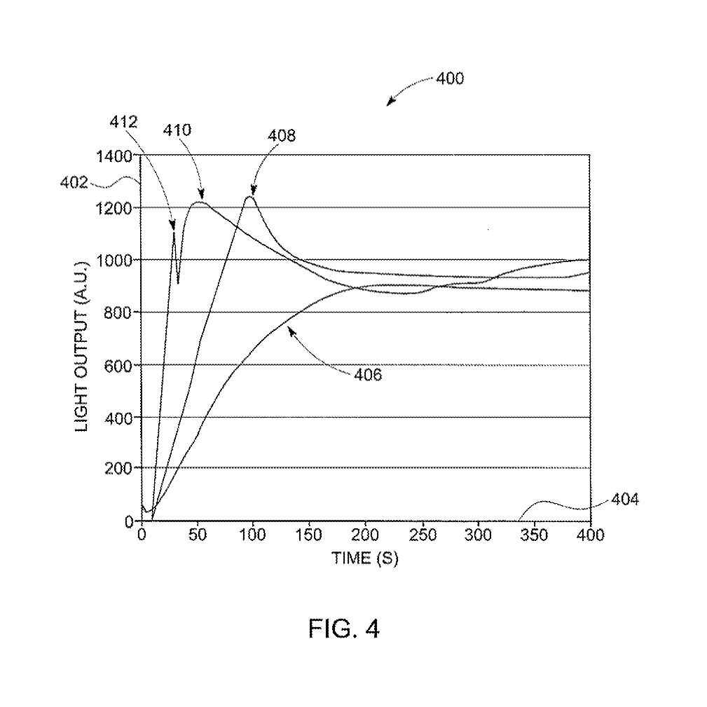

FIG. 4 is a graph 400 of light output versus time illustrating the run-up improvement of a lamp driven using the lamp driving module 210 incorporating aspects of the disclosed embodiments. In this illustration, the light output 402 in terms of Absorption Units (a.u.) is shown on the Y-axis, while time 404 in terms of seconds is shown on the X-axis. The same fluorescent lamp design employing a single amalgam was used for all the data in graph 400. As discussed above, the amalgam 150 is placed near the electrode 126 that becomes the anode during DC operation. Curve 406 illustrates the light output versus time for a standard AC ballast lamp configuration driven only in an AC mode. With only AC drive power it takes over a minute for the lamp to reach 60% brightness and about three minutes to reach full brightness. Curve 408 illustrates light output versus time for a DC driven lamp, where the amalgam side of the lamp is the anode. Curve 408 shows improved light output achieved when the lamp 100 is initially driven in a DC mode for a startup period then switched to the AC mode. Curve 410 illustrates the benefits of using DC Boost. In this example, the lamp 100 is initially driven with DC power with a doubled average current until the spike 412. The lamp 100 is then switched to an AC power mode. Thus, driving the lamp 100 during run-up with DC power using the lamp driving module 210 described herein will accelerate heating of the amalgam 150 in the lamp 100 resulting in faster release of mercury vapor, and will also accelerate migration of the released mercury vapor throughout the discharge tube 102 through electrophoresis.

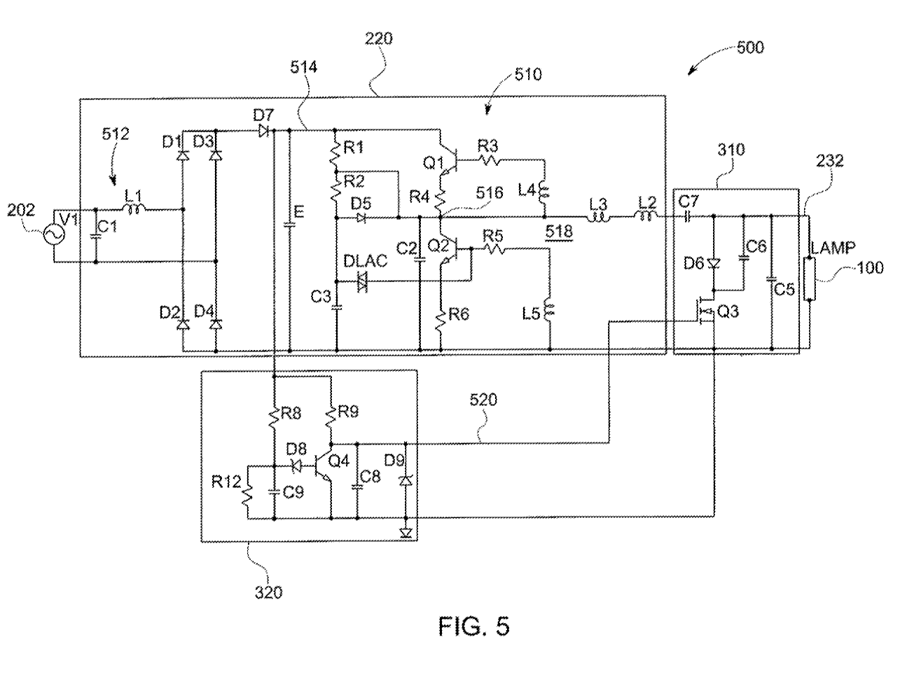

Referring now to FIG. 5, a schematic diagram 500 of one embodiment of the driving module 210 shown in FIG. 3 is illustrated. Although a specific circuit configuration is shown in FIG. 5, it will be understood that alternative circuits and/or implementations that achieve the same functionality of switching to a DC mode during run-up to heat the amalgam 150 in the lamp 100 more quickly, accelerate migration of the released mercury vapor throughout the discharge tube 102, and allow the lamp or light 100 to get brighter faster, could also be implemented. In this particular example, the driving module 210 receives power V1 from a suitable AC power source 202 and the module 210 includes the ballasting module 220, power switching module 310 and timer module 320. The functional block boundaries defining the modules 220, 310 and 320 are included as an aid to understanding only, and should not be interpreted as limiting the disclosure in any way.

In the embodiment shown in FIG. 5, the diodes D1, D2, D3, and D4 of module 220 form a diode bridge which full wave rectifies the AC input power V1 from the AC power source 202. Buffer capacitor E provides smoothing of the full wave rectified power produced by the diode bridge to get a DC supply voltage 514 that is fed to the half bridge inverter 510. A protection diode D7 prevents any unwanted voltage spikes that may be produced by the half-bridge inverter 510 from reaching the bridge diodes D1, D2, D3, or D4. An electromagnetic interference (EMI) filter 512 formed by a capacitor C1 and an inductor L1 is used to minimize the disturbance transmitted towards the input AC power source 202. Alternatively, an EMI filter can be placed on the DC supply voltage 514 between the buffer capacitor E and the inverter 510. The exemplary half-bridge inverter 510 is of the instant-start type to obtain an almost immediate light output from lamp 100. During a startup phase of the inverter 510 the DC supply voltage 514 is applied to the buffer capacitor E via the inductor L1. The buffer capacitor E reduces the ripple voltage caused by the full wave rectified AC input power from the AC power source 202. The result is a high DC supply voltage 514 applied to the half-bridge inverter 510. The half-bridge inverter includes bipolar switching transistors Q1, Q2, and a resonant tank formed by inductor L2 and capacitors C7 and C5. A driving transformer 518, that includes primary winding L3 and secondary windings L4, L5, is used to drive the switching transistors Q1, Q2 through driving resistors R3 and R5. During the startup phase, capacitor C3 is charged from the DC supply voltage 514 via the resistors R1 and R2. As soon as the voltage across C3 reaches the breakdown voltage of the diode for alternating current (DIAC), such as for example 32 volts, the DIAC will breakdown and transistor Q2 is switched on. Resistor R1 ensures that the half bridge midpoint voltage, at node 516, is set to the input on the DC supply voltage 514 before the DIAC is triggered. When switching transistor Q2 turns on, the half bridge midpoint voltage on DC supply 514 changes rapidly from the DC input voltage on 514 to zero volts so that a positive voltage is applied to the secondary winding L3 of the drive transformer 518 and keeps transistor Q2 conducting. After switch-on of transistor Q2, diode D5 discharges C3 to prevent double triggering of transistor Q2 while capacitor C2 prevents capacitor C3 from being discharged before oscillations begin. At this point, the half-bridge 510 is oscillating and the start module is deactivated by diode D5. D6 is used to ensure that Q3 does not conduct any reverse current, as some of the available MOSFETs have an integrated backwards-conducting diode built-in. Resistors R4 and R6 limit current flowing thorough the transistors Q1 and Q2 respectively.

After the half-bridge inverter 510 is started it enters an ignition phase to ignite the lamp 100. In the ignition phase, the resonant components—inductor L2 and capacitors C7, C5—form a series resonance module which is able to generate a large voltage across C5. The worst case ignition voltage is about 900 Volts peak for a fluorescent lamp at low temperatures. The combination of ballast coil L2 and igniter capacitor C5 is chosen to ensure that while the voltage across the lamp 100 can exceed the ignition voltage, the current through the switching transistors remains below an acceptable level, such as below about 1.5 A. The lamp driving module 500 is able to re-ignite the lamp 100 for mains voltages down to about 150 Vᵣₘₛ.

Once the lamp 100 is ignited the driving module 500 enters a burn phase where the lamp 100 will become low ohmic and requires ballasting or control of the current flowing through the lamp 100. Current through the lamp 100 is controlled primarily by inductor L2 in conjunction with the operating frequency of the half-bridge converter 510, which in certain embodiments may be about 28 KHz. During the burn phase, the impedance of igniter capacitor C5 is high compared to the lamp impedance so its influence on the lamp current may be regarded as negligible.

In the embodiment shown in FIG. 5, the power switching module 310 works in conjunction with the timer module 320 to provide DC power to the lamp 100 for a predetermined period of time after the lamp 100 is ignited. In this example, after the predetermined period of time, or when the lamp 100 reaches a desired operating point, the power switching module 310 switches to provide AC power to the lamp 100. Alternatively, the power switching module 310 may be switched based on any suitable criteria other than including time, such as for example the light output or temperature of the lamp 100. This can be advantageous in those situations where the lamp 100 has been operating and has achieved the desired brightness or temperature. In those situations, the lamp driving module 210 can include suitable sensors that detect light output and/or temperature. In one embodiment, the assembly 200 can include one or more controllers (not shown) that can be used to detect and determine light output and/or temperature of the lamp 100 as well as determine when to control the lamp 100 in a DC mode or an AC mode. The controller(s) can include one or more processors that are comprised of machine-readable instructions that are executable by a processing device for determining when to control the lamp 100 in a DC mode and in an AC mode. In one embodiment, the controller(s) can include or be coupled to one or more memory devices or assemblies for storing data, information and instructions.

In the embodiment shown in FIG. 5, a field effect transistor Q3 is used to switch the power switching module 310 between the AC and DC modes. When transistor Q3 is open, i.e. not conducting, the power switching module 310 behaves as a standard AC ballast, AC power is applied to the lamp 100 and the lamp current is prevented from exceeding a safe operating level. When the transistor Q3 is closed, i.e. transistor Q3 is conducting, the transistor Q3 shorts the output 232 of the power switching module 310 to ground through a diode D6 during the positive half period of the AC lamp power signal on the output 232. Thus, during the positive half-period, current flows through this shorted module 232, and not the lamp 100, thereby charging capacitor C7. When the output 232 of the power switching module 310 changes polarity, the diode D6 stops conducting and current flows through the lamp 100. Capacitor C6 stabilizes voltages across the diode D6. The charge placed on capacitor C7 during the positive half-cycle now flows through the lamp 100 resulting in a current through the lamp 100 that is larger than the average current flowing in AC mode. In this way the lamp 100 conducts only every second half-cycle with an average current that is generally the same as the average AC current.

In the illustrated embodiment, the timer module 320 is used to switch the output 232 of the power switching module 310 between DC and AC modes. The operation of timer module 320 is based on the charging time of capacitor C9 through a current-limiting resistor R8. When the lamp driving module 210 is first started, there is no charge on the capacitor C9 and transistor Q4 is turned off, i.e. not conducting, resulting in an output 520 from the timer module 320 that is high, which puts the power switching module 310 in DC power mode. When the voltage of the capacitor C9 reaches the breakdown voltage of the zener diode D8, the zener diode D8 starts to conduct causing the transistor Q4 to turn-on which in turn changes the output 520 from high to low. When the output 520 is low, the transistor Q4 is turned off, returning the output 232 of the power switching module 310 to the AC power mode. The timer module 320 includes a Zener diode D9 to protect the output 520 from excessive voltages along with a capacitor C8 to add voltage filtering. Resistor R9 limits current flow through transistor Q4 and resistor R12 provides a discharge path for capacitor C9 to reset the timer module 320.

In DC power mode, the exemplary driver module 210 provides DC power to the lamp 100 that has an average current substantially the same as the average current supplied to the lamp 100 during AC power mode. Using a method referred to as DC Boost, higher levels of DC power can be provided to the lamp 100 resulting in additional reductions in run-up time. For example in one embodiment, the lamp power control module 230 of FIG. 2 may be configured to supply an average DC current in DC power mode that is double the average current supplied in AC power mode.

The exemplary embodiments described above use DC power when the lamp 100 is initially started, and then switch to an AC mode to power the lamp 100. In some embodiments, it may be desirable to avoid switching from DC power to AC power. In these embodiments, the AC power mode and DC power mode can be combined by applying an AC power signal to the lamp 100 that includes a DC bias. By applying a DC bias along with the AC power, some of the benefits of increased anode heating and electrophoretic migration can be obtained without the need to switch power modes. In this embodiment, the lamp power control module 230 of FIG. 2 is configured to apply a DC bias to the AC power signal received from the ballast module 220. The power output 232 applied to the lamp 100 will include the AC power signal and the DC bias.

As described above, the run-up time can be reduced in fluorescent lamps that have an amalgam near one of the electrodes by driving the lamp with DC power such that the electrode adjacent the amalgam is an anode. In one embodiment, heating of the amalgam 150 can be further accelerated by reducing thermal resistance between the anode surfaces and the amalgam. For example, conductive or metal parts, such as a wire (not shown) can be inserted between surfaces of the electrode structure 126 and the amalgam 150 to provide a thermal conduction path to transfer heat from the electrode structure 126 to the amalgam 150. A thermal conduction path is a path or structure with reduced thermal resistance that is in thermal communication with both the electrode structure 126 and the amalgam 150 to allow heat to easily move from the electrode structure 126 to the amalgam 150. A conduction path can be formed by placing a metal structure, such as for example a metal wire, with one end in thermal communication with lead-in wires 128 and the other end in thermal communication with the amalgam 150. Alternatively the conduction path can be formed from any material having a low thermal resistance that can be placed in thermal communication with the electrode structure 126 and the amalgam 150.

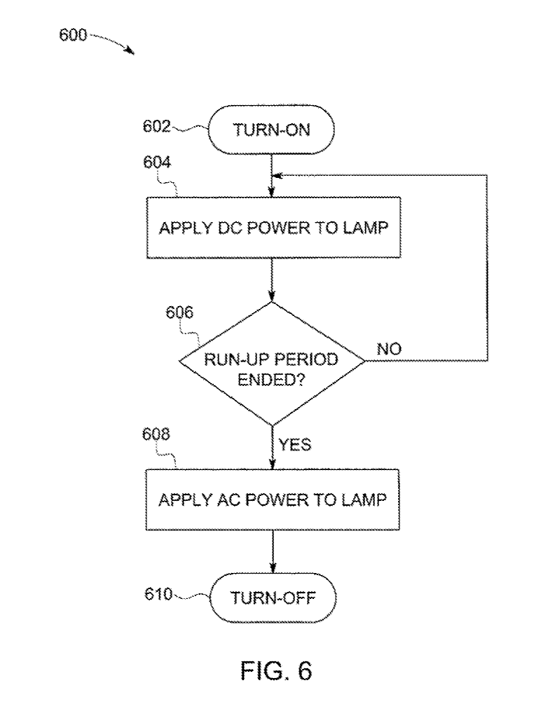

FIG. 6 illustrates an exemplary embodiment of a process 600 for driving a fluorescent lamp that achieves such an improvement in run-up time. In one embodiment, the process 600 detects when the lamp 100 is turned on or initially activated 602. The lamp is then operating in a run-up state where it is driven with DC power in a DC mode 604. The DC power is applied in the DC mode 604 with a polarity that causes the electrode near the amalgam to become the anode. Next, a check is made 606 to determine the operating state of the lamp. The operating state may be determined by checking if the run-up period has ended 606 or by checking whether another pre-determined criteria has been satisfied, such as lamp brightness or temperature. If the run-up period has not ended, i.e. the lamp is still operating in the run-up state, the path labeled “No” is taken, and the process remains in the DC mode 604, applying DC power to the lamp 100. If the run-up period has ended and the lamp is no longer operating in the run-up state, the path labeled “Yes” is taken, and the process switches to an AC mode 608 where AC power is applied to the lamp 100. When the lamp 100 is turned off 610, power is no longer applied. In one embodiment, the end of the run-up period is determined by waiting a predetermined amount of time. Alternatively, the operating state of the lamp 100 may be determined 606 by other methods such as for example monitoring the light output of the lamp and waiting until the light output exceeds a threshold amount, or waiting until the amalgam exceeds a threshold temperature. The amalgam temperature is an indicator of the amount of mercury vapor in the lamp. The light out of the lamp 100 is related to the amount of mercury vapor in the lamp 110. The amalgam temperature can be used as an indicator of the light output. For example, in one embodiment, when the lamp 100 is initially turned on, also referred to as the initial activation of the lamp, 602, it is determined whether a run-up period is required. This can include detecting an initial brightness or light output of the lamp 100 and/or temperature of the lamp 100. Those skilled in the art will recognize that other methods of determining the beginning and the end of the run-up period may be used without straying from the spirit and scope of the disclosed embodiments.

The aspects of the disclosed embodiments address the problems associated with the run-up time typically associated with fluorescent and compact fluorescent lamps and lights. In an initial start-up or run-up phase of the lamp, the lamp is driven in a DC mode of operation. After a pre-determined time period, such as the end of the run-up period, when the lamp has achieved a pre-determined brightness or temperature, or another determining factor, the aspects of the disclosed embodiments switch the operation of the lamp back to the AC mode of operation. During this run-up period, the amalgam at the anode side of the lamp heats up faster due to electron heating and cataphoretic migration accelerates the distribution of mercury vapor inside the discharge tube. Thus, the light gets brighter faster or sooner.

Thus, while there have been shown, described and pointed out, fundamental novel features of the invention as applied to the exemplary embodiments thereof, it will be understood that various omissions and substitutions and changes in the form and details of devices illustrated, and in their operation, may be made by those skilled in the art without departing from the spirit and scope of the invention. Moreover, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A lamp driving module for a gas-discharge lamp comprising:
a lamp ballast module; and
a lamp power control module coupled to the lamp ballast module;
wherein the lamp power control module is configured to drive the lamp in a DC mode during a run-up state.

2. The lamp driving module of claim 1, comprising an AC power input to the lamp ballast module.

3. The lamp driving module of claim 1, wherein the gas-discharge lamp is a fluorescent lamp.

4. The lamp driving module of claim 1, wherein the lamp power control module is configured to operate the lamp in the DC mode for a predetermined period of time and operate the lamp in an AC mode after the predetermined period of time.

5. The lamp driving module of claim 1, wherein the lamp power control module comprises a power switching module coupled to the ballast module and a timer module coupled to the power switching module and the ballast module.

6. The lamp driving module of claim 5, wherein the timer module is configured to detect an initiation of the run-up period and enable the power switching module to operate the lamp in the DC mode.

7. The lamp driving module of claim 6, wherein the ballast module is configured to indicate the initiation of the run-up period to the timer module.

8. The lamp driving module of claim 1, wherein the DC mode comprises an AC power signal with a DC bias.

9. The lamp driving module of claim 1, wherein the lamp power control module comprises:
an input coupled to the ballast module;
an output coupled to the lamp; and
a switching device coupled between the input and the output;
wherein when the switching device is not conducting, the output to the lamp comprises an AC power signal for the AC mode and when the switching device is conducting the output to the lamp comprises a DC power signal for the DC mode.

10. The lamp driving module of claim 1, wherein the lamp power control module is configured to:
detect an activation of the lamp;
determine an operating state of the lamp; and
drive the lamp in one of an AC mode or the DC mode in dependence on the operating state of the lamp.

11. The lamp driving module of claim 10, wherein the operating state is determined on the basis of the run-up state, a temperature of the lamp or a brightness of the lamp.

12. A gas-discharge lamp assembly comprising:
a ballast module;
a lamp driving module coupled to the ballast module and configured to produce a lamp power signal; and
a lamp coupled to the lamp driving module and configured to receive the lamp power signal for operation of the lamp; and
wherein the lamp driving module is configured to provide a DC power signal or an AC power signal to the lamp.

13. The lamp assembly of claim 12, wherein the lamp driving module is configured to:
detect an initial activation of the lamp;
provide the DC power signal to the lamp for a predetermined period of time; and
provide the AC power signal to the lamp after the predetermined period of time.

14. The lamp assembly of claim 12, wherein the lamp further comprises:
a discharge tube having a first end and a second end;
a first electrode disposed at the first end of the discharge tube;
second electrode disposed at the second end of the discharge tube;
an amalgam disposed in the first end of the discharge tube; and wherein the first electrode is coupled to a supply side of the AC or DC power signal.

15. The lamp assembly of claim 14, further comprising a conducting structure having a first end and a second end, wherein the first end is in thermal communication with the first electrode, and the second end is in thermal communication with the amalgam, and wherein the conducting structure is configured to have a reduced thermal resistance.

16. The lamp assembly of claim 15, wherein the conducting structure is a metal structure.

17. The lamp assembly of claim 13, wherein the conducting structure is a metal wire.

18. A method for operating a gas-discharge lamp comprising:
applying a DC power to operate the lamp during a run-up state; and
applying an AC power to operate the lamp at an end of run-up state.

19. The method according to claim 18, comprising wherein the end of run-up state comprises an end of a pre-determined time period, a light output of the lamp exceeding a pre-determined light output threshold or a temperature of the lamp exceeding a pre-determined temperature threshold.

20. The method according to claim 19, wherein the lamp includes an amalgam and the pre-determined temperature threshold is a temperature of the amalgam.
